(19) United States
(12) Patent Application Publication
(10) Pub. No.: US 2015/0215245 A1
(43) Pub. Date: Jul. 30, 2015

(54) USER INTERFACE FOR GRAPHICAL REPRESENTATION OF AND INTERACTION WITH ELECTRONIC MESSAGES

(71) Applicants: Matthew Christian Carlson, Seattle, WA (US); Alexander Frank, Bellevue, WA (US)

(72) Inventors: Matthew Christian Carlson, Seattle, WA (US); Alexander Frank, Bellevue, WA (US)

(21) Appl. No.: 14/163,996

(22) Filed: Jan. 24, 2014

(51) Int. Cl. H04L 12/58; G06F 3/0482; G06F 3/0488

(52) U.S. Cl. CPC H04L 51/046; G06F 3/0488; G06F 3/0482

(57) ABSTRACT

A method and a device are disclosed including a user interface configured to display and manage grouped graphical representations of electronic data and messages, such as files and emails, that can be zoomed in to access different types of information and details about one or a group of messages. The user interface further allows searching for, dispositioning, and taking various actions on one or a group of messages. In various embodiments, the graphical representation includes grids of grids or tiles, and in other embodiments, it includes fractal representations such as quadratic fractals. At least four types of zoom operations are disclosed including digital zoom to enlarge images, context-zoom to show different information types about messages like folders, categories, collections, etc. depending on context; semantic-zoom to show different data depending on level of detail; and metadata-zoom to show metadata about a message such as timestamp, existence of attachments, and the like.

### CROSS-REFERENCE(S) TO RELATED APPLICATION(S)

This application claims the benefit of the filing date of the U.S. Provisional Patent Application 61/759,938, entitled “USER INTERFACE FOR GRAPHICAL REPRESENTATION OF AND INTERACTION WITH ELECTRONIC MESSAGES,” filed on 1 Feb. 2013, the disclosure of which is hereby expressly incorporated by reference in its entirety, and the filing date of which is hereby claimed under 35 U.S.C. §119(e).

### TECHNICAL FIELD

This application relates generally to electronic message management. More specifically, this application relates to graphical representation and manipulation of messages in a graphical user interface having message zoom, search, and filtering capabilities.

### BRIEF DESCRIPTION OF THE DRAWINGS

The drawings, when considered in connection with the following description, are presented for the purpose of facilitating an understanding of the subject matter sought to be protected.

FIG. 1 shows an example network computing environment wherein the disclosure may be practiced;

FIG. 2 shows an example computing device that may be used in the network computing environment of FIG. 1;

FIG. 3A shows an example horizon view of multiple electronic messages usable with the computing device of FIG. 2;

FIG. 3B shows an example fractal representation of multiple electronic messages useable with computing device of FIG. 2;

FIG. 4A shows an example context zoom usable with the horizon view of FIG. 3;

FIG. 4B shows an example touch-based user interface for switching between various message folders;

FIG. 5A shows an example semantic zoom usable with the horizon view of FIG. 3;

FIG. 5B shows example zoom in and zoom out operations on a set of messages in horizon view;

FIG. 6 shows the example meta zoom usable with the horizon view of FIG. 3;

FIG. 7A shows an example search user interface configured to allow searching for electronic messages;

FIG. 7B shows example search control panel options for zoom and pan operations usable with the search user interface of FIG. 7A;

FIG. 7C shows example search user interface with video-game style thumb control areas configured to allow searching for electronic messages;

FIG. 7D shows example control panel options for action or person selection operations usable with the search user interface of FIG. 7C;

FIG. 7E shows example search and/or interface, with multiple date range and pan controls options, configured to allow organizing and/or searching for electronic messages;

FIG. 8 shows an example calendar view of groupings of electronic messages;

FIG. 9A shows an example arrangement configured to triage and disposition electronic messages;

FIG. 9B shows an example arrangement configured to allow selection of an electronic message for disposition; and

FIG. 9C shows an example action set for a selected electronic message usable with the arrangement of FIG. 9B.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references electronic mail (email), it will be appreciated that the disclosure may be used with other types of electronic messages and records, such as SMS, IM, social network posts, text messaging, chat records, files, folders, icons, and the like.

Briefly described, a device and a method are disclosed including a user interface software component configured to dynamically display and manage grouped graphical representations, such as tiles, of electronic data and messages, such as files and emails, that can be zoomed in to access different types of information and details about one or a group of messages. The user interface is further configured to allow automatic and/or dynamic changes to the appearance and contents of tiles based on relevance and other factors, and further allow searching for, dispositioning, and taking various actions on one or a group of messages. In various embodiments, the graphical representation includes grids of grids or tiles, and in other embodiments, it includes fractal representations such as quadratic fractals. At least four types of zoom operations are disclosed including digital/optical zoom, context-zoom to show different information types about messages like folders, categories, collections, etc. depending on context; semantic-zoom to show different data depending on level of detail; and metadata-zoom to show metadata about a message such as timestamp, existence of attachments, and the like.

A number of companies produce office software products, which typically include communication and messaging email and calendaring programs, such as Microsoft Office®, Corel (Word Perfect Suite), Oracle Open Office®, and others. Historically these programs ran and worked locally on the user's computer, using only the resources that were available on the local system. However, in the recent years, many other software applications have been devised and made available that provide various types of communications. With the advent of advanced or smart mobile devices, such as smartphones, SMS, text messaging, and emails are more widely available and used than ever before.

With the ubiquity of reliable and widely available internet access, there is an ever increasing number of electronic messages that are transmitted and/or stored. Accordingly, incoming messages, such as emails and text messages, accumulate fast and are difficult and time consuming to effectively manage. A user interface that can help users quickly view, categorize, search for, disposition, and take appropriate actions on messages is highly desirable.

### Illustrative Operating Environment

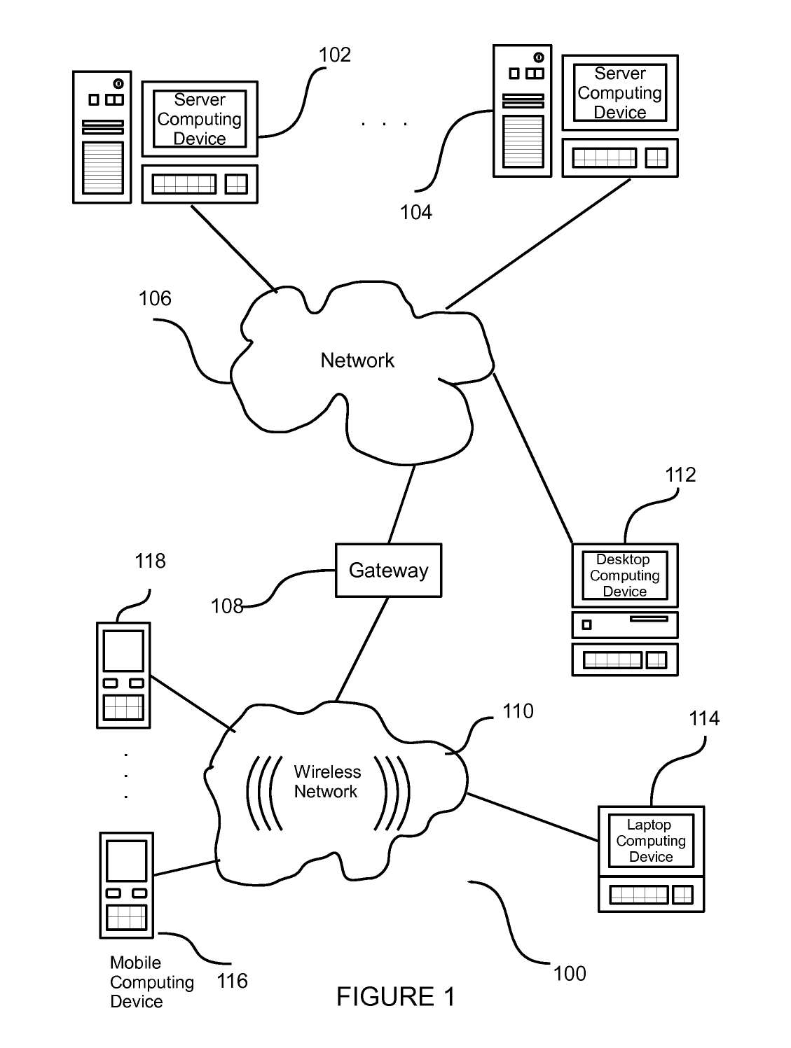

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

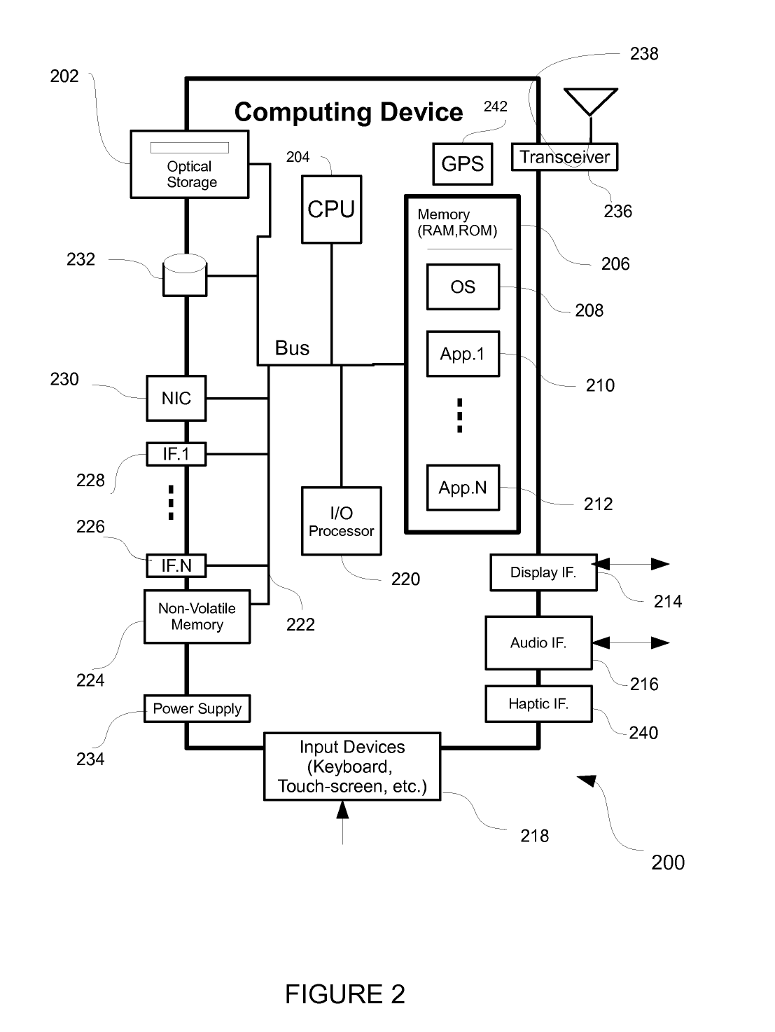

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

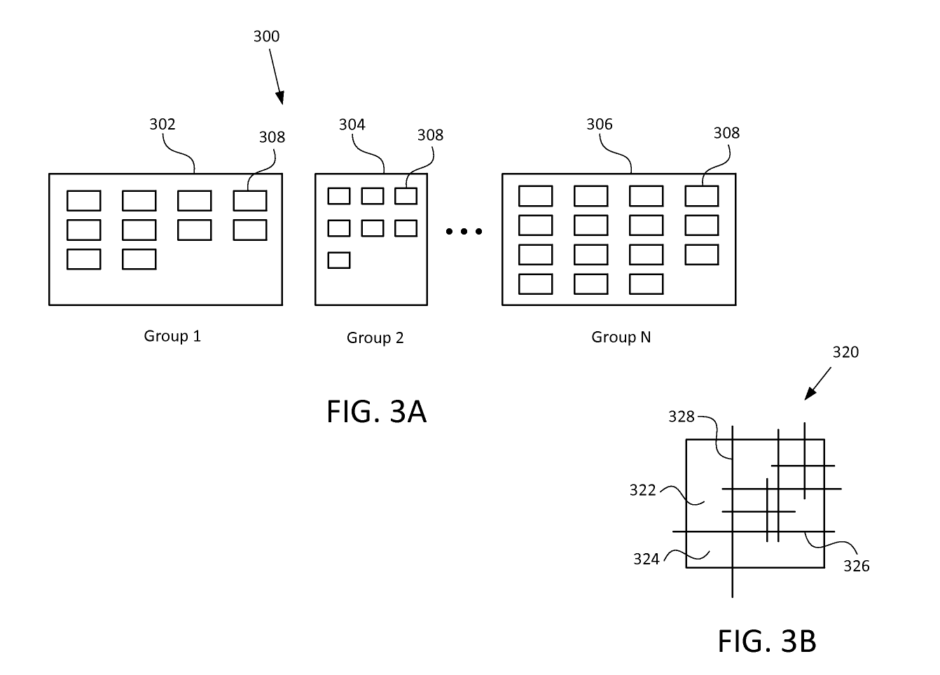

FIG. 3A shows an example horizon view of multiple electronic messages usable with the computing device of FIG. 2. In various embodiments, horizon view 300 depicts many electronic data representations 308, such as email messages, grouped together in various grids representing different groups 302, 304, and 306.

In various embodiments, electronic data items may include email, SMS, voicemail, video mail, chat records, files, folders, applications, applets, apps, pictures, images, network nodes, software components, web-based posts like message posts to Facebook, or any other electronic information which may be represented by a graphical component such as an icon or a tile. An icon is usually a static pictogram which when selected, for example, by a mouse click, causes some software action, such as the launching of an application to take place.

In various embodiments, a tile is usually an active relatively small graphical component and/or user interface, such as an applet or small software application, which displays sample graphical or visual information related to bigger bodies of information related to software applications the tiles represent. When selected, tiles display more complete information, such as a file or web page contents, related to the sample information; launch their respective associated applications; or bring them to the forefront of the display and assume focus for the user's input actions. For example, a tile representing an email application may show some information about the email inbox such as the number of new messages, fragments of the most recent message, and the like. As another example, a tile representing a message, may display an image of the sender and overlay some text from the message, such as its subject line. Tiles are generally dynamically updated to reflect the change of data in the applications they represent. Such dynamic tiles may be considered as small live windows to the applications they represent, thus, efficiently showing the user status and other information about multiple applications, which otherwise would not be possible due to the limited size of the computer screen. So, for a given screen size tiles can always display information about a greater number of applications to the user than could be done with full applications. Those skilled in the art will appreciate that any image, on a paper, a computer screen, or otherwise, is a projection on a plane having two dimensions, usually referred to as X and Y dimensions or axis, also referred to as X-Y plane. However, In various embodiments, an arbitrary number of dimensions may be included in the image using various visual effects or data manipulations. In this context, a dimension is any variable, parameter, or category of information related to a graphical representation of data. For example, in a message, various dimensions may include sending/receiving/opening time, sender, receiver, priority, relevance, importance, thread, subject category, and the like. In a static image only two such parameters may be displayed. But in a dynamic image an arbitrary number of such parameters may be accessed via various techniques described below.

To access such additional information or dimensions, various techniques may be used. For example, 3-D visual effects, such as perspective projection with stacked data items, may be used to show an additional Z-axis. Stacked data items show a stack of items at one point or coordinate in the X-Y plane, so that for every point on the X-Y plane a group of items exist, instead of a single data item. This technique effectively provides the Z-axis on the X-Y plane. More dimensions may be included in a dynamic image on an electronic display by various navigation and manipulation techniques to access more information related to a particular area of the image, such as drill-down into the area, opening stacked data items, context driven menu items by selection of the area, or any other graphic technique that allows retrieval of additional information, corresponding to different dimensions.

In various embodiments, in addition to explicitly defined dimensions, attributes, or parameters, described above, information, such as meta data related to the electronic data items like messages, may be contained in other aspects of the graphical representations, such as in color, shape, texture, imagery, and size, among others. For example, in the context of messages, icons or tiles representing older messages may be shown with faded colors, while newer messages may be represented with the same but a more vivid color. Similarly, older messages may be shown as smaller icons while newer ones are shown as larger icons. As another example, if a sender is known to the user, the messages from the sender are displayed with bright colors, while more faded colors may be used for lesser known or unknown users. Those skilled in the art will appreciate that various graphical attributes such as color, texture, size, and shape, among others, may be used to encode or indicate various information such as meta data, as described above.

Those skilled in the art will appreciate that any such parameter variations may be used to differentiate between different data items or their associated meta data. For example, texture, size, color, screen position/location, or other visual attributes of graphical representations such as icons may be varied to indicate the relevance of a particular electronic data item (e.g. a message) to a current activity the user is engaged in. Again, in a messaging context, if the user is reviewing his emails, more prominent attributes may be used to represent emails that are more relevant to a thread, sender, time period, subject, and the like. For instance, a more relevant email may be displayed with bolder texture, more vivid color, or in larger size relative to other emails.

Generally, relevance indicates how closely an item or a result is related to a desired objective or activity. In various embodiment, the relevance may be based on one or more various relationships or parameters that are predefined, dynamically and automatically determined based on usage history or user preferences, or explicitly specified by the user. For example, in a messaging system such as email, a particular email may be considered as being more relevant if its time parameter is recent and it has the same subject line as other emails that the user has recently opened. Any combination of parameters or relationships may be used to indicate relevance, depending on the application or user preferences.

In various embodiments, the characteristics of visual or graphic representation of electronic data items may be automatically determined based on context, history of usage, or set preferences. In other embodiments, such characteristics may be set by a user via a user interface for setting preferences. More specifically, visual characteristics of data items may be automatically assigned based on item category, relevance, priority, history of usage or preferences, location (obtained from GPS, cell towers, user input, etc.), importance, and the like. For example, a highly relevant data item related to a particular project may be automatically displayed as a larger icon with bright colors in the center of the display screen, while less relevant data items may be displayed as small gray items on the side of the display screen.

In various embodiments, automatic machine or self-learning of relevance factors and the preferences of the user may take place by the system implementing the data item management user interface, based on the user behavior, preferences, user's responsiveness to a type of message, amount of time user spent on a type of message, and usage history of the various electronic data items. For example, in a messaging context, the system may learn that messages from a particular sender or on a particular subject as characterized by certain keywords, cause the user to respond immediately or spend more time on the message. In such case, the system may automatically display the messages that fit the learned criteria more prominently, for example, by size, screen placement, color, or other attributes. Those skilled in the art will appreciate that many other parameters and techniques may be used to learn without departing from the spirit of the present disclosures. For example, duration of time the user spent on a particular data item fitting certain conditions, searches performed on such data items, and the like, may be used to develop a pattern of usage to identify future data items matching the same criteria or patterns.

In various embodiments, parameters, attributes, or criteria assigned to a dimension, such as X, Y, or Z dimensions, allow ordering of data items displayed along the dimension. For example, if X-axis is assigned the time parameter, then email messages received may be ordered and displayed on the screen according to the time of delivery, time of sending or opening, or other time-based criteria. Similarly, a dimension may be assigned an alphanumerically ordered parameter, such as sender name or ID. One or more dimensions may be ordered, each based on a different order. For example, the X-axis may be ordered by time, while the Y-axis is ordered by priority.

As another example, the X-axis and Y-axis may define a coordinate system guiding the placement of messages. The X-axis may be used to project orderable categories defined by time ranges, such as Today, Yesterday, Last Week, Last Month, etc. The Y-axis may be used to project or enumerate some other categorized domain, which may include at least the following and other categories: work related, personal, shopping and promotions, TEXT-messages, social-network messages, v-mails (voice mail), and miscellaneous. As can be appreciated by those skilled in the art, multiple messages may fall onto the same coordinates, for example, Today and Work categories. These messages may be stacked or organized in small sub-grids 302-304-306, resulting in a grid-of-grids in horizon view 300, where the coordinates of each sub-grid imply the message time and context. Effectively, this arrangement is similar to an attraction map of a city, except that it is a map of messages.

Those skilled in the art will appreciate that ordering is not limited to predefined ordered sets such as the set of integers, date and time, or alphabetical sets. Other sets of values for a particular parameter may be provided, which are ordered according to a predefined enumeration. For example, a set of subjects or names may be specified in a set and each assigned an order with respect to the other set members. In some embodiments, the order may be calculated dynamically. For example, a relevance score may be calculated, based on various criteria described above, for each electronic data item and used to order the display of the data items. in this example, a message with a higher relevance order may be presented ahead of or in front of another message with a lower relevance score.

In various embodiments, the grids' and tiles' visual characteristics are automatically adjusted. The order, size, arrangement, color, and other visual characteristics of the electronic data items, such as messages or web posts like notes on Facebook “wall”, may be determined and/or adjusted by the system automatically without user involvement. For example, in a messaging context, the tiles representing individual messages or groups of messages may be arranged based on chronological order, each with varying sizes and colors based on age, relevance, subject, sender, message category, past user behavior, user preferences, or other criteria. Similarly, the shape and size of the grids of grids, in the horizon view, may be automatically determined and dynamically updated as conditions change. For example, as new messages come in, they are displayed with more vivid and bright colors, by varying color hue, saturation, intensity (or value or lightness), and in larger size, while older messages are reduced in size and shown in faded colors to deemphasize the old or less relevant messages.

In various embodiments, electronic messages and records, such as SMS, text messaging, chat records, files, folders, icons, and the like are clustered to form groups of similar data records. In the case of emails, such groups may include subject-based categories like “Inbox,” “Sent,” “Personal,” “Work,” and the like. Similarly, such groups may include period or time-based categories like “Today,” “Yesterday,” “Last Week,” and the like. Those skilled in the art will appreciate that for different types of electronic data, different types of groups or categories may be defined as appropriate for the type of data. For example, for file and folder data, the categories might be subject-based, size-based, project-base, person-based, time-based, file type-based, or any other appropriate and useful category that may be used to group files and folders.

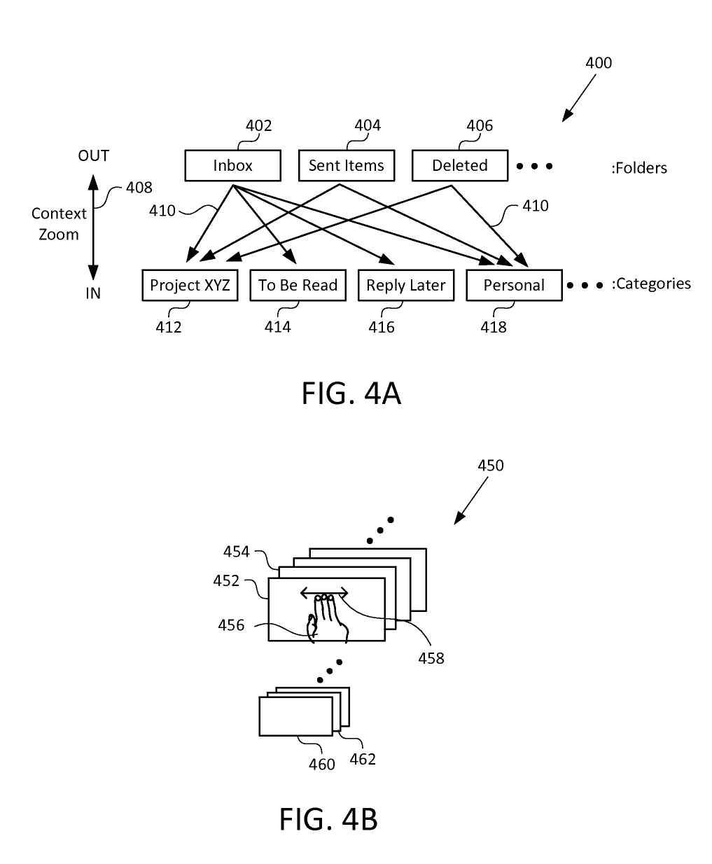

Horizon view allows quick review of electronic data, such as emails, at a high level, without having to closely examine individual emails or folders. For example, the horizon view might include the number of data records and other statistical information associated with each group. This way, a user may quickly obtain useful statistics about the group. In various embodiments, further details about single records, such as email messages, may be obtained by using various zoom operations as further described below with respect to FIGS. 4A, 5, and 6.

In various embodiments, the horizon view, when deployed on a computing device with a multi-touch screen, provides easy and fast touch techniques for manipulating one or a large group of data records, such as emails. For example, groups may be shuffled around and manipulated by a swiping action of a finger. Similarly, a group may be zoomed in or zoomed out by a pinch-in or pinch-out action of two fingers, revealing more or less information about the zoomed group.

In some embodiments, a group of data records or a single data record may be selected to be dispositioned or to have other appropriate action taken on it. For example, an email may be selected to be transferred to the “Personal” folder, be marked as “Read,” or be deleted.

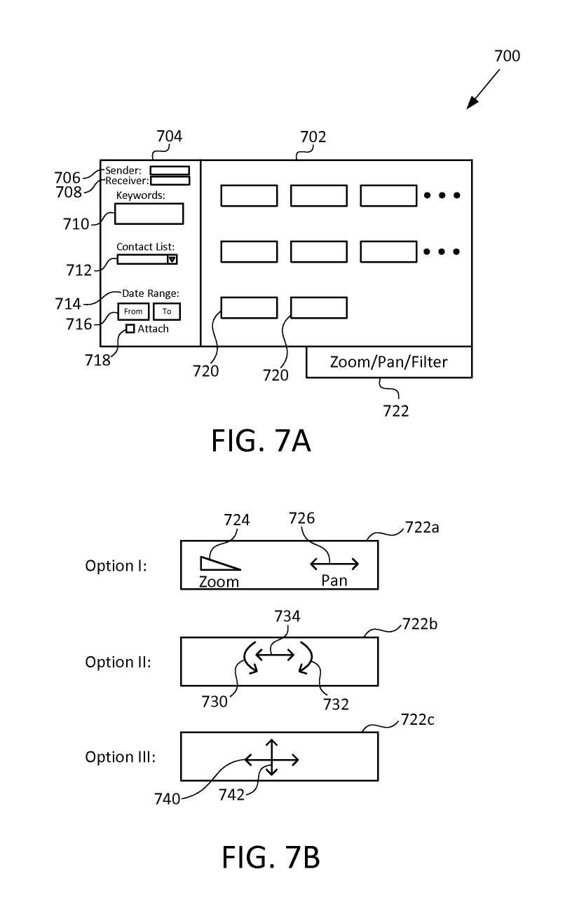

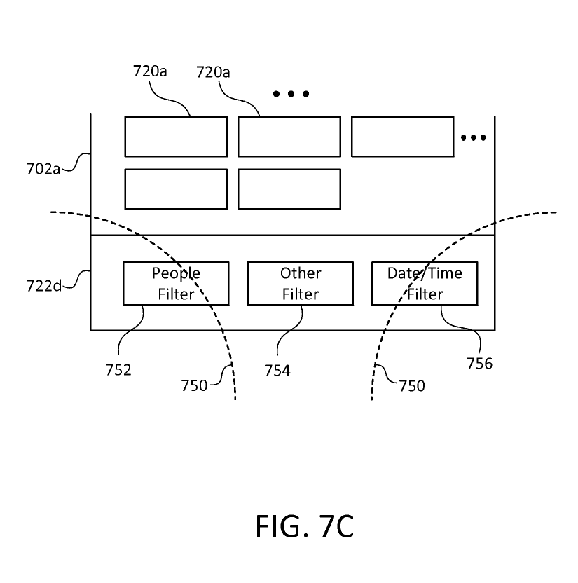

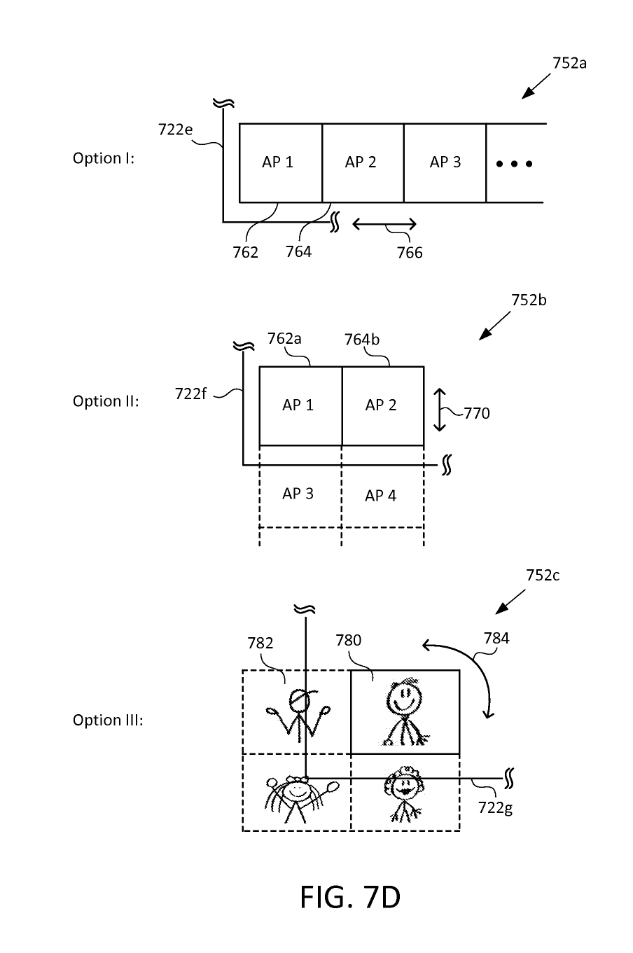

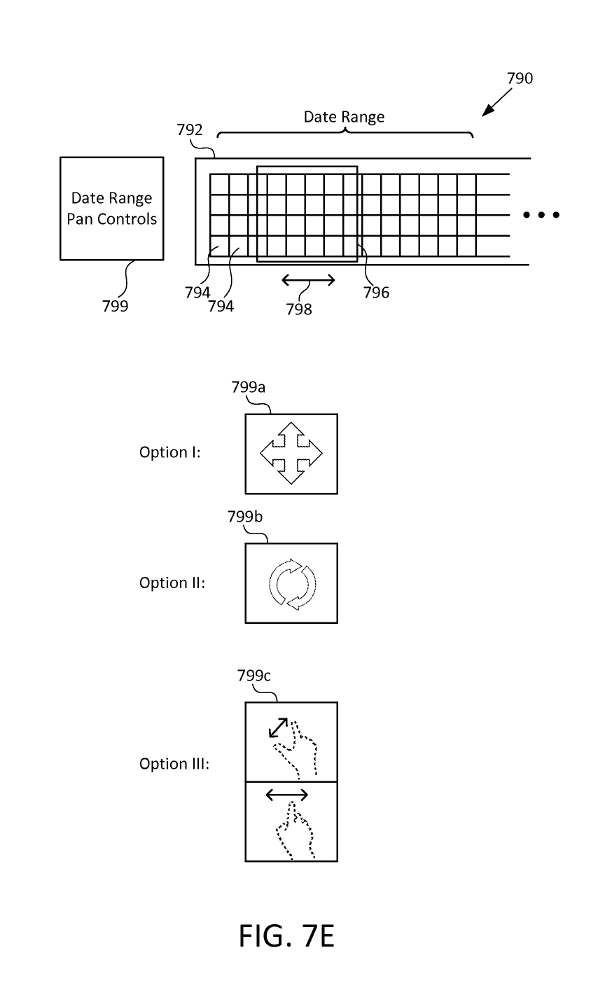

In some embodiments, a range of an appropriate quantity, such as time period, in a group may be selected for further actions. For example, in time-based groups, a range of three days may be selected to further examine in details, as further described below with respect to FIG. 7E.

In some embodiments, electronic data items grouped together as grids or grids of grids, may be color coded to easily visually identify different groups. The grids may be nested to an arbitrary depth, each nested set representing a level. For example, the top level grid may be level 1, the next nested level may be numbered level 2, and so on. Each grid level may have its own characteristics and attributes, some or all of which are shared with the higher or lower level grids. In a messaging context, if time is used for nesting grids, the top level may represent a year and/or month, the next level may represent a week or day, and the next level may represent a sender or a thread of conversation. Each of these levels may be represented by a different color, shape, meta data, and the like. The zoom operations described herein may be used to move between grid levels by zooming in and out. In various embodiments this arrangement may be represented by a fractal model like the one shown in FIG. 3B.

In other embodiments the data items may be identified by geometric shapes like squares, circles, triangles, and the like, or by irregular shapes such as silhouettes of objects, people, or animals, or any other shapes easily distinguishable from others. In still other embodiments, a combination of shapes, colors, and textures may be used to group items together to distinguish them from other groups. At each zoom level (or level of detail) various distinguishing characteristics, such as color, shape, texture, marks, flags, indicators, text, and the like may be used to distinguish groups or items from others, at that level.

In various embodiments, a graphical tile-based electronic data item handling system including the horizon view interface 300 may be implemented by a hardware and/or software system using one or more software components/modules executing on the illustrative computing device of FIG. 2. One or more functions may be performed by each software module recorded on a medium such as an optical disk, magnetic disk or tape, volatile or non-volatile computer memory, and the like, or transmitted by various communication techniques using various network and/or communication protocols, as described above with respect to FIG. 1. For example one or more separate software components may be used for each of the functions of displaying, categorizing, performing various zoom operations, responding to user touch commands/gestures, updating color of tiles based on changing situation or data, updating size and texture of tiles based on changing situation or data, determining relevance, and the like as described herein. For instance, a context zoom software module, a message relevance software module, a touch gesture processing module, and the like, may be among the software components used to implement the messaging system which includes horizon view. Those skilled in the art will appreciate that one function may implemented using multiple software modules or several functions may be implemented using one software module. With further reference to FIG. 2, these software modules are generally loaded into the memory module 206 of the computing device for execution.

FIG. 3B shows an example fractal representation of multiple electronic messages useable with computing device of FIG. 2. In various embodiments, the organization principle of electronic data items, such as email messages, may be guided by a fractal. Fractal representation 320 includes a quad fractal diagram, which may be successively divided into four equal or non-equal quadrants 322, 324, and the like, using dividing lines 326 and 328. At next level, one or more of the quadrants may be further subdivided into four equal or non-equal sub-quadrants. This process may continue to a desired level. Each level corresponds to a quadrant or sub-quadrant in the quad fractal diagram. So, the highest and least detailed square or rectangle may be labeled as level 1. When this level 1 square is subdivided into four quadrants, each quadrant corresponds to level 2. And when one or more of the quadrants is further divided into two or more sub-quadrants, the sub-quadrants correspond to level 3. This subdivision of quadrants may continue to an arbitrary level, such as level N. Each such level also corresponds to a zoom level, with level 1 corresponding to highest zoom out and level N corresponding to lowest zoom in.

Briefly, a fractal is a self-similar pattern which looks the same or similar at every scale. So, the fractal pattern looks the same looking at it from far away or close up. Fractals form an area of mathematics that study continuous but non-differentiable functions and have other mathematical properties in addition to self-similarity. Those skilled in the art will appreciate that a fractal model is not limited to a quad fractal as described above. Any number of subdivisions of various shapes may be used in other embodiments, without departing from the spirit of the present disclosures.

In various embodiments, the fractal representation of electronic data items may be used instead or in addition to the horizon view. For example, in some embodiments, the fractal representation may be used as a model for managing zoom operations in the background while the horizon view is used as the primary user interface model. In other embodiments, the fractal representation may also be used for some aspects of the user interface.

FIG. 4A shows an example context zoom usable with the horizon view of FIG. 3. In various embodiments, context zoom operation 400 includes high level data items 402, 404, 406, and the like, zooming onto corresponding detailed aspects embodied in low level (detailed) data items 412, 414, 416, 418, and the like, as appropriate, and as represented by arrows 408 and 410.

Context zoom allows more detailed information to be accessed by zooming in on a horizon view of electronic data items, such as emails, based on context using a context zoom operation. In various embodiments, zooming operations may be done using a variety of user interface techniques, such as multi-touch screen pinching, as further described at least with respect to FIG. 7B. In various embodiments, the context of zooming in on a data item may be determined or specified by various characteristics of the computing environment and/or of the data item, such as type of the electronic data item, applicable operations, prior operations in a sequence, the location of the device, current date/time, and the like. In some embodiments, context zoom allows categorization of the content in the data items. For example, a message folder such as “Inbox”, may be selected by a user and then zoomed in to reveal its contents and types or categories of messages it contains, such as “Personal” messages, “To be read” messages, and the like.

In various embodiments, digital zoom of graphical components may be used to better see details of the graphical component without addition of any new information. The digital zoom is equivalent to an optical zoom on a physical lens. The digital zoom may be used in addition to other types of zoom described herein.

In various embodiments, the high level data items may include folders, accounts, categories, collections, auto-generated groups or sets, organization hierarchies, and the like. The high level data items may be categorized according to many criteria, such as subject, time, people, purpose, actions to be taken and the like. For example, the high level data items may include “Project XYZ,” “Web Accounts,” “Gift Ideas,” “Receipts,” “Personal,” “Flagged,” “Unread,” “To Be Read,” “Reply Later,” “Recently Accessed,” “From Daily Deal Sites,” and the like. The low level, or lower level data items, may include various detailed information about the selected high level data items depending on the context. For example, if the “Flagged” category of high level data items is selected, zooming in may reveal the types of flags (status or property markers) currently set on the data items and/or the types of flags available. Or if the “To Be Read” category is selected, then zooming in might present message priority, days since receipt of the message, and the like.

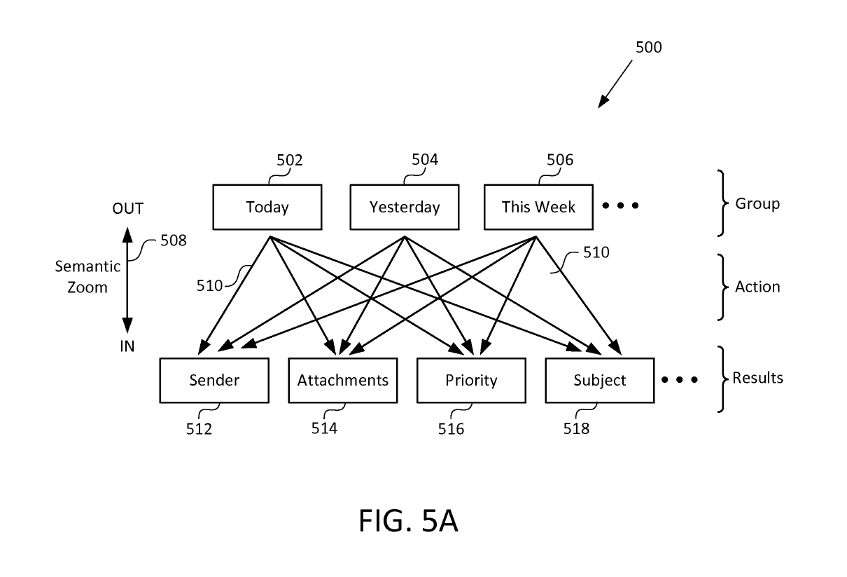

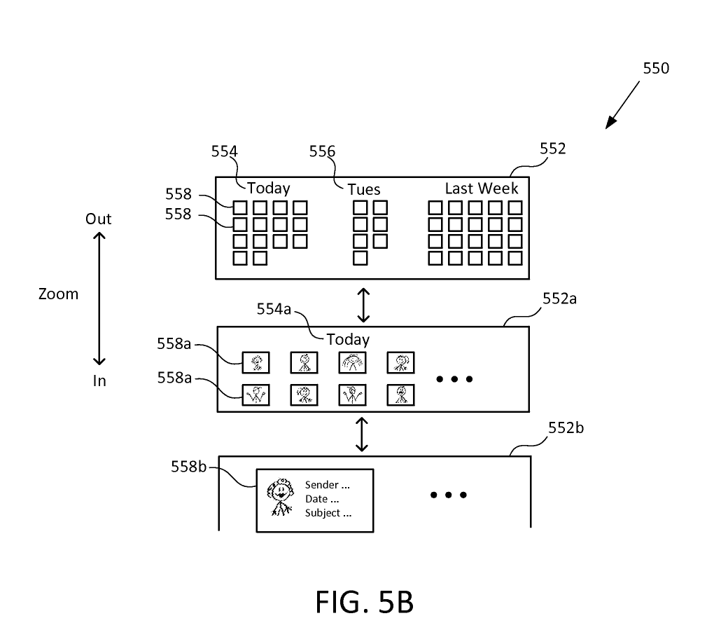

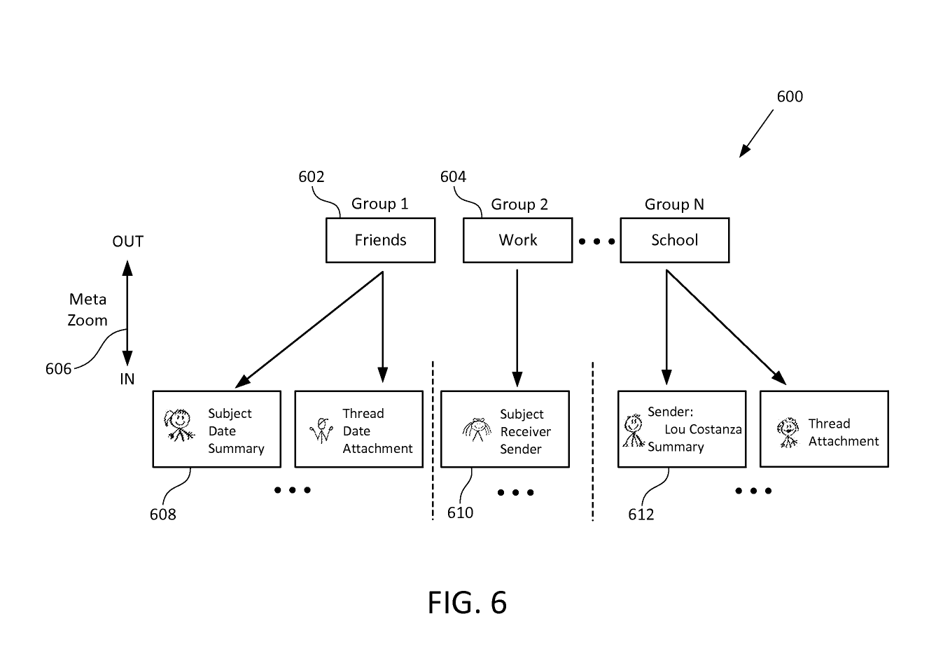

In some embodiments, contextual zoom may also act like a filter to allow the user to select various groupings of data items, such as email messages, for the application of other zoom operations such as semantic zoom and meta zoom, as further described below with respect to FIGS. 5 and 6. For example, the user may use multi-touch gestures, such as pinching or stretching the screen with two fingers, to reveal various folders such as “Inbox,” “Sent,” and the like, and select one which is later the object of other zoom operations, such as semantic zoom, to show further information associated with the selected folder.

In operation, in some embodiments, the user may select a group of data items, such as emails, grouped together based on a parameter such as a time of receipt like all emails from yesterday. The user may then elect to zoom in on the selected group using the context zoom operation. The zoom operation may result in more details of the selected group of data items being shown, including individual emails, sender's name, date, receivers, subject, permissible actions, and the like. In some embodiments, a limited number of zoom levels may be available, such as two levels, a high and a low, while in other embodiments, multiple zoom levels may be available. Still in other embodiments, a continuous zoom operation may be presented which allows seeing more and more details and data associated with the electronic data item, and consistent with the context of the data item, as the user zooms in.

In various embodiments, the type of the zoom operation is selected automatically by the computing system based on context. For example, at a top level with the fewest details, such as the horizon view, zoom actions by the user may result in the contextual zoom operation, at mid-levels of detail, semantic zoom may be activated, and at the lowest levels (having highest amounts of detail), meta data zoom may be employed. In other embodiments, the user may select the type of zoom operation to employ, for example, initial setup or by explicit selection before performing the zoom operation. In still other embodiments, a specific zoom operation may be selected by a combination of user preferences and a state or action of the system.

FIG. 4B shows an example touch-based user interface for switching between various message folders. In various embodiments, touch-based user interface 450 includes various message folders 452 and 454, which may be exchanged by hand gesture 458, while pinned message folders 460 and 462 may continue to remain in their assigned positions.

In various embodiments, graphically represented data entities, such as message folders 452 and 454, may be easily moved around brought to the foreground from the background of a computer screen using various hand gestures. In one embodiment, a multi-finger (referring to user behavior), for example, three-finger, multi-touch (referring to device and/or display characteristics) hand gesture may be used to graphically move data entities. For example, the three-finger gesture may be a smooth motion to one side, sliding the top data entity to one side and revealing the entities underneath; it may be a reciprocating motion causing the top entity to go the bottom of the stack of entities and bringing the next entity up to the foreground; it may be three-finger tap on the top entity to take some action such as moving it up or down or to the bottom of the stack; and the like.

In various embodiments, one or more tiles 460, 462 may be pinned to a designated pinning area of the screen, automatically or under user control. Tiles may be pinned to the pinning area based on various criteria such as user preferences, incomplete actions on the item represented by the tiles, high relevance to a current user task, designated senders or receivers, designated subject matter, designated time range, designated categories, or any other criteria that may be used to distinguish one or more electronic data items, such as messages, from others. In some embodiments, such pinned messages may be excluded from automatic adjustment, such as fading or reduction in size, sometimes applied to older or less relevant messages in the horizon view.

FIG. 5A shows an example semantic zoom usable with the horizon view of FIG. 3. In various embodiments, touch-based user interface 500 includes groups 502, 504, and 506, semantic zoom 508, actions 510, and results 512, 514, 516, and 518.

Semantic zoom generally allows more detailed information to be accessed by zooming in on an electronic data item, such as an email, based on zoom level, using a semantic zoom operation. Semantic zoom presents different types of data associated with the data item being zoomed, depending on the level of the zoom. Such data are hidden in various storage or software layers and are only accessible when at a particular zoom level. In various embodiments, zooming operations may be done using a variety of user interface techniques, such as multi-touch screen pinching and stretching, as further described at least with respect to FIG. 7B.

In various embodiments, semantic zoom 508 combines elements of visual or graphic zoom by making a data item representation, such as an icon or tile, visually larger to show more detailed data related to the semantics of the zoom level. For example, a small icon representing a data item, such as an email, may be represented as a small colored rectangle at a high level (low detail). Zooming in on the group or item to a lower level (more detail) may reveal more visual as well as semantic details, such as internal divisions on the data item or group like visual sections within the data item's graphic representation, and semantic data like sender's name and picture, date of transmission, and the like.

In various embodiments, groups of data items, such as email messages, are specified and formed based on different criteria or parameters, such as time, subject, action status, people, projects, priority, importance, relational considerations like being personal or work related, size, statistical data like number of receivers or number of messages from the same sender, a combination of some of the above, or any other defined criteria. In some embodiments, the grouping may be performed on user instructions, while in other embodiments, the grouping of data items may be done automatically and/or dynamically by the system without direct user action. In some embodiments, predefined criteria and/or rules may be used by the system to form or reconfigure groups when such criteria or rules are satisfied or become applicable, respectively. For example, a rule may be specified that triggers the grouping of messages into a new group when the number of emails from a particular sender exceeds a predefined threshold.

In various embodiments, semantic zoom may provide a number of appropriate actions at each zoom level. For example, at the highest level, the actions available to the user may include moving groups around on the screen, changing group colors, changing grid dimensions, changing grid shapes, and the like. At a lower level, the appropriate actions may include specifying the types of information displayed on each message, such as the name and picture of the sender, the subject, the date, and the like. Still at a lower and more detailed level, the appropriate actions may be moving the message to a different folder, replying to a message, marking the message for future actions, deleting a message, and the like. In some embodiments, some of the various actions available at the various zoom levels may be regarded as filters operable to select and separate certain data items from others.

The results of the actions taken at a semantic zoom level may appear as new groups or subgroups of the messages zoomed. For example, semantic zoom starting from a high level having time-based grouping, such as “Today,” “Yesterday,” “Last Week,” etc., may create subgroups for a selected group, which may include “Sender,” “Priority,” and the like. This is similar to a filter operation, which filters or separates messages into various subgroups. So, all the messages in “Today” high level group, when zoomed in, may result in the sub-grouping of the messages contained in the Today group.

FIG. 5B shows example zoom in and zoom out operations on a set of messages in horizon view. In various embodiments, horizon view 550 includes groups of data items 554 and 556 on a screen 552, each group including data items 558. Zooming in transforms group 554 to more detailed group 554a and data items 558a on screen 552a. Zooming in further reveals more details about data items 558b in screen 552b. For example, group 554 in a high level (low detail) state horizon view shown on screen 552 may include email messages from today. Zooming in to a mid level (mid detail) state shown on screen 552a reveals more details about the group and the data items 558a contained therein, such as small icon-type pictures of senders, colors, or other similar information. Zooming further to a still lower level (more detailed) state shown on screen 552b provides more details about individual data items such as clearer pictures, more colors, text, marks, and the like.

In various embodiments, the various zoom functions described herein may implemented by one or more zoom software modules/components. Those skilled in the art will appreciate that generally a zoom-in operation is a traversal from a high-level view (low detail) of a data item to a low-level view (high detail), and a zoom-out operation is a traversal in the reverse direction. However, each type of specific zoom provides a different type of detail. For example, the contextual zoom operation provides context-based detail, the semantic zoom provides relevant details to the level of zoom or detail, and the metadata zoom provides metadata which is indirectly relevant to the zoomed data item at the given zoom level.

FIG. 6 shows the example meta zoom usable with the horizon view of FIG. 3. In various embodiments, meta zoom operation 600 includes high level (low detail) data entities such as groups 602, 604, and the like; low level (high detail) data entities 608, 610, 612, and the like; and zoom in and zoom out actions 606.

Generally, meta zoom operation provides access to meta data appropriate to the level of the zoom. Those skilled in the art will appreciate that meta data are information about data. For example, meta data about a text file may include information about the text file, such as date of creation, file size, file type, and the like, as contrasted with the file contents. Meta data generally has only a peripheral relationship to the data which it describes, and different data may have the same meta data while the same data may have different meta data.

Each of the high level groups 602, 604, and the like may be defined to be mapped to certain meta data, via meta zoom operation, that is appropriate for the selected group. For example, if the group selected is “School,” then the appropriate meta data may include attachment types, while if the group selected is “Friends,” then the appropriate meta data may include information about a conversation thread. In various embodiments, such meta data may be predefined, while in other embodiments, they may be set or changed by the user. The use of meta data may be particularly beneficial in a customer or client context, in which meta data may be used to indicate, for example by color or flag, whether a response has been sent to an important customer message.

In various embodiments, when a user generally zooms in on an electronic data item, such as an email message, more detailed information about the zoomed data item are presented, some of which may be meta data. For example, as the user zooms in on a particular message group and then a particular message, the contents of the message, the sender, the subject, the date, and other similar information are presented. Some meta data may also be presented which is only related to the message itself and not its contents, such as the IP address the message is associated with, the folder the message appears in, statistics about the message's senders and/or receivers, the size of the message, the size and number of attachments, and the like.

In some embodiments, multiple levels of presentation of data are employed, each corresponding to a zoom level or a range of zoom levels, and each level defining particular attributes and methods for the presentation of such data. For example, in one level, the data may be presented graphically, while at another level, the data may be presented textually. In still other levels, a combination of graphical and textual data may be presented. Colors, shapes, textures, marks, fonts, flags, symbols, icons, or combinations thereof, and the like may all be used in creating data presentations at various levels as appropriate for the level of presentation. In the case of messages, the data may include name of the sender, date of transmission, subject, contents, attachments, types of attachments, size of message, related threads of messages, related projects, related folders, and the like.

The various information types related to an electronic data item may be viewed as parameters forming an N-dimensional space, each dimension being one of the information types or parameters. For example, in the case of messages, time, message size, and number of receivers are continuous or sequential parameters, while sender, subject, folders, and type of attachments are discrete parameters or enumerations. The messages may be filtered or selected based on any combination of such parameters. For example, the user can filter messages based on the age of the message, the sender, the subject, the attachments, and the like, or any combination thereof, as applicable or appropriate.

In various embodiments, the meta zoom operation may operate within the other zoom operations, such as the contextual or the semantic zoom. For example, the user may zoom in on a data item using semantic zoom operation, or the system may automatically apply the semantic zoom operation in response to user's zoom command or action, and once at a lower level (more detailed level), the meta zoom may be selected or activated to show meta data. In some embodiments, any zoom operation may operate within or in conjunction with other zoom operations. For example, a user may utilize a meta zoom operation first, and then perform a semantic zoom operation on the meta data returned from the meta zoom operation. In some embodiments, one or more particular zoom operations may be automatically selected by the system based on context or various criteria without explicit user input (other than the zoom command itself) at the time of zoom operation, while in other embodiments, the user may select the type of zoom operation to be performed.

In some embodiments, the type of data presented to a user as a result of various types of zoom operations are predefined, while in other embodiments, the type of data are defined by a user, such as a system administrator or an end user, during an initialization session or using an interface for setting options or preferences. In still other embodiments, the type of zoom data may be dynamically determined or changed. In yet other embodiments, the type of data are determined by a combination of two or more of the foregoing.

FIG. 7A shows an example search user interface configured to allow searching for electronic messages. In various embodiments, search user interface 700 includes data item panel 702 presenting data items 720, search parameter panel 704 having various search parameters such as sender 706, receiver 708, content keyword field 710, contact list 712, data range 714 showing start date 716, and end date 718, and zoom control panel 722.

In various embodiments, the search user interface 704 is used to specify the search criteria according to which electronic data items are sought and presented to the user. Those skilled in the art will appreciate that many more criteria than those shown in FIG. 7 may be used in the search interface without departing from the spirit of the present disclosures. In general, any of the parameters/dimensions/information types and meta data associated with the electronic data item, such as messages, may be used as a search criteria. For example, subject, sender (such as “mail from your boss”), recipients, text, type of attached files like text or image, priority, reply status, thread, and the like, may be used as search parameters to search for and select messages that are to be displayed as search results.

In various embodiments, depending on the type and nature of the search parameter, either a range or a discrete value is specified for searching. For example, a date range may be specified for the time parameter and a particular name may be specified for the sender. In some embodiments, the search criteria available via the search interface may be predefined, while in other embodiments, the search criteria may be added dynamically by the user. For example, the user may use a software button or other similar interface to add more criteria for search and may further specify the combinatorial logic for combining the various criteria. For instance, two criteria may be logically “ANDed” or “ORed” together, meaning both criteria must be satisfied or either one alone must be satisfied, respectively, to qualify a message to be in the search results.

In various embodiments, zoom control panel 722 may include several sections or control interfaces, such as zoom control, pan control, and other filter controls, as further described with respect FIG. 7B. As described above, at least with respect to FIGS. 4A, 5A, and 6, the zoom interface is used to provide more detail about a group of items or an item. Several types of zoom are available such as contextual zoom, semantic zoom, and meta zoom. In the context of search, the zoom control allows selection of subgroups within a larger group of items by zooming in and reducing the number of data items under consideration within the group being zoomed. The reduction in number of data items within the group during a zoom operation may be in addition to simultaneously presenting other information about the group or data items. So, for example, as described with respect to FIG. 5B, when zooming in, not only more information are shown about the group or data item, such as color, text, texture, pictures, and the like, but also fewer data items are placed in view of the user, effectively filtering the number of data items or groups to a smaller number.

In various embodiments, a pan operation moves a viewing window of the user over a large set of data items, effectively filtering the large set to the size of the viewing window. The viewing window may be explicit or implicit. An explicit window may appear as a window wire frame superimposed over a set of data items, while an implicit window simply shifts a series of data items in one direction, such as left or right (or up and down) so that only a subset is visible at a time. For example, a viewing window may be used over a group of 500 emails distributed in a horizon view, as shown in FIG. 3. As the user pans the viewing window to right or left, a substantial part of the 500 emails falls outside the viewing window. This process is further illustrated in FIG. 7E. Generally, the zoom operation changes the level of detail, while the pan operation moves the focus or viewing window over data items at the level determined by the zoom operation. This way, both operations serve to limit the number of data items in the search results.

In various embodiments, as the search criteria in search parameter panel 704 are used to find selected data items that match the search criteria, the number of such data items may further be reduced by zoom and pan operations. For example, if one of the search criteria is time, the zoom and pan operations may be used to traverse dates and focus the search on a range of dates most relevant to the objectives of the search.

In various embodiments, contact list 712 may be part of or based on a more comprehensive address book or directory service. The directory service may aggregate user information from various sources, such as social networks like Facebook, Google+, Microsoft's SOCL, Window Live, Hotmail, Microsoft Outlook, Yahoo, and the like, databases, individual or public websites, company websites, web services, other directory services, and other interface services. The contents of such address book or directory service may include one or more of various users' names, nicknames, titles, aliases, addresses, email addresses, pictures, company logos, trademarks, and the like.

In various embodiments, various address book information may appear on tiles at some zoom levels. For example, when searching for a message matching certain search criteria, the search results may be displayed with some of the address book information included in the tile, such as a user's name and picture, or a company logo corresponding to the message sent from a particular company.

In various embodiments, the zoom control panel 722 may be distributed over the entire screen, or on dynamically selected areas of the screen occupied by the horizon view, rather than a designated area. For example, the user may simply pinch any tile directly to zoom out instead of selecting a tile and then using a separate zoom control panel to effect a change in the tile.

FIG. 7B shows example search control panel options for zoom and pan operations usable with the search user interface of FIG. 7A. In various embodiments, the zoom control panel 722 of FIG. 7A may be implemented in various ways, such as Options I, II, and II of FIG. 7B. Option I includes a zoom control panel 722a having zoom control 724 and pan control 726. Option II includes a zoom control panel 722b having zoom controls 730 and 732 and pan control 734. Option III includes a zoom control panel 722c having zoom control 742 and pan control 740. Those skilled in the art will appreciate that many other zoom and pan control interfaces are possible without departing from the spirit of the present disclosures.

In various embodiment, zoom control panel 722a is used to control zoom and pan operations. Zoom control 724 may be applied by dragging a software slider that shown the level of zoom as being high or low, as signified by the triangle. For example, as the slider is dragged, dark bars may appear within a portion of the triangle indicating the level of zoom or a color filled portion of the triangle may appear indicating the level of zoom. The color may change for each zoom level, discretely or continuously. Pan control, represented by arrow 726, may be used to pan left or right on a large data set to move an implicit or explicit viewing window.

In various embodiments, zoom control panel 722b is used to control zoom and pan operations. Zoom control 730 and 732 may be applied by tracing a finger along the curved arrows to zoom in or out. The level of zoom as being high or low, may be signified by color or shading or other visual means. For example, as the curves are traced a color filled portion of the arrow may appear indicating the level of zoom. The pan control 734 is similar in operation to the pan control 726 of Option I.

In various embodiments, zoom control panel 722c is used to control zoom and pan operations. Zoom control 742 may be applied by tracing a finger along the vertical arrow to zoom in or out. The level of zoom as being high or low, may be signified by color or shading or other visual means. For example, as the arrow is traced a color filled portion of the arrow may appear indicating the level of zoom. The pan control 740 is similar in operation to the pan control 726 of Option I.

In various embodiments, user commands to the user interface may take the form of indirect commands such as spoken or voice commands, hand gestures, device-based remote commands, or any other technique that can be used to convey a command to the electronic data item user interface. The user commands may be for any purpose such as manipulating and navigating data items, searching, triage, or any other interaction with the user interface.

In various embodiments, voice commands are predefined keywords spoken and received by the computing device running the user interface. The commands are then passed onto the user interface software for interpretation and execution with the same effect as the direct commands such as touch or mouse based commands. For example, a voice command such as “zoom in” or “zoom out” would result in the current display being zoomed in or zoomed out, respectively.

In various embodiments, hand gesture commands may be used and remotely detected by a camera or other sensor without touching the screen. Some real-time interactive products on the market, such as Microsoft's Kinect, detect body movements, process it in software, and display reactions to such movements appropriate for an application or game. For example, if the user is playing video tennis, Kinect detects the movements and responds by displaying an opposing computerized player hitting back a computerized tennis ball to the user.

In various embodiments, a remote device such as a video game controller, or TV remote controller, may be used to issue commands to the user interface, similar to other commands described above. The commands may be implemented as predefined signals, such as infrared signals, which are transmitted to the system for detection and execution upon pressing one or more hardware buttons or other actuators such joysticks, thumbwheels, and the like.

In various embodiments, an output interface transforms the results of commands to verbal information or information written in a different language. For example, a voice interface may be used to transform text and other data to spoken information. In still other embodiments, a language translation interface may allow selection of data items by the user and translate the content of such data items to another language of choice for the user.

Availability of such indirect commands that do not depend on direct input of command to the computing device, allow users with various impairments or deficiencies to use the system. For example, visually impaired persons, those with different languages, computer-illiterate people, people with advanced age, and the like, may benefit from these alternate command and output interfaces.

In various embodiments, other user input devices such as mouse, touchpad, and the like may be used to perform various operations, such as zoom and pan, described herein.

FIG. 7C shows example search user interface with video-game style thumb control areas configured to allow searching for electronic messages. In various embodiments, data items panel 702a includes data items 720a, zoom control panel 722d having left filter control 752, middle filter control 754, right filter control 756, and thumb control areas 750.

In various embodiments, data items panel 702a is similar to the data items panel 702 of FIG. 7A, in appearance and function. Also, zoom control panel 722d is similar to the zoom control panel 722 of FIG. 7A in function and purpose, however, it is different in operation in some aspects. In tablet type touch screen computing devices, typically held by two hands, working with thumbs to operate the touch screen is often convenient, natural, and fast. This configuration is similar to video game controllers. In some embodiments, the thumb control areas 750, indicated by the dotted line boundaries, are located at the bottom left and right of the screen superimposed on top of left and right filter controls 752 and 756. In various embodiments, the filter controls 752, 754, and 756 may include people selection, date range selection, subject selection, or any of the other search parameters available or defined for limiting the number of search matches.

In various embodiments, zoom control panel 722d may be substantially similar to those shown in FIG. 7B for zoom and pan control, while in other embodiments, the zoom control panel may include other interfaces and techniques for specifying search criteria and implementing zoom/pan controls, as further described below with respect to FIG. 7D.

In some embodiments, zoom control panel 722d may be user configurable, while in other embodiments, the zoom control panel is preconfigured. In some embodiments, zoom control panel 722d may include only the left, middle, and right filter controls, 752, 754, and 756 respectively, while in other embodiments, the zoom control panel may include any number of such search filters. The embodiments in which the user may configure the zoom control panels, the user may select how many filter controls and which types to be placed within the zoom control panel. For example, the user may choose four filter controls, including a left, two middle ones, and a right filter control. The user may further select the type of filters such as filters for selecting people, date range, priority, type of attachments, and the like. Depending on the type of filter selected, a zoom and/or pan control may be incorporated into the filter to allow easy zooming in and out by quick thumb operations. For example, date range may be a common use for zoom and pan controls.

In various embodiments, screen orientation, such as landscape or portrait orientations, may determine the thumb control areas. For example, the thumb control areas may shift to different areas of the screen as the screen orientation is changed by a rotation of the physical screen.

In various embodiments, the screen size and device weight may influence the positioning of thumb controls. For example, in a tablet there may be two such control areas in the bottom corners while in a smartphone a thumb control may be positioned or rendered in the center of the screen. As can be appreciated by those skilled in the art, flexible control positioning on touch screen may be applied to other types of controls and control areas in addition to thumb controls. For example, various touch-based or remotely-detected finger or hand gestures, remote control devices, and the like, may be configured, dynamically or preconfigured, to apply to different areas of the screen based on the computing device, screen type and size, application, or other criteria.

In various embodiments, the screen touch control areas may be adjusted automatically by monitoring, learning, and reconfiguring the screen control areas based on the user's habits and hand/finger size. For example, if the user has longer fingers and tends to reach farther inside the screen for control, the control areas may be extended by the system to accommodate the user.

FIG. 7D shows example control panel options for action or person selection operations usable with the search user interface of FIG. 7C. In various embodiments, Action or Person (“AP”) filters may be implemented in various ways, as indicated by example Options I, II, and III, in FIG. 7D. Option I includes zoom control panel 722e, analogous to zoom control panel 722d of FIG. 7C, AP filter set 752a configured to allow selection of particular people or actions with regard to a data item search, AP filters 762 and 764, and shift operation 766 for horizontally shifting or sliding AP filters back and forth for selection. Option II includes zoom control panel 722f, analogous to zoom control panel 722d of FIG. 7C, AP filter set 752b configured to allow selection of particular people or actions with regard to a data item search, AP filters 762a and 764a, and shift operation 770 for vertically shifting or sliding AP filters back and forth for selection. Option III includes zoom control panel 722g, analogous to zoom control panel 722d of FIG. 7C, AP filter set 752c configured to allow selection of particular people or actions with regard to a data item search, AP filters 780 and 782, and shift operation 784 for rotationally shifting or sliding AP filters back and forth for selection.

In some embodiments, the various search and/or filter functions described herein are implemented using one or more search or filter software components and modules. The AP filter set 752a of Option I is an implementation of left or right filters 752 and 756 of FIG. 7C, where the filter set may be manipulated by user's thumbs in normal operation. The user may horizontally shift the AP filters 762 and 764 back and forth to select a desired person or action appropriately associated with one or more messages the user is searching for. For example, the user may search for a message sent by a particular sender during a particular date range, such as last week. The user may then use this control mechanism for selecting an action to be performed on the message so found. The action may be to reply, to mark, to archive, to delete, to forward, or do any other action that is appropriate for the given message or other type of data item the user is searching for.

In some embodiments, AP filter set 752b of Option II is an implementation of left or right filters 752 and 756 of FIG. 7C, where the filter set may be manipulated by user's thumbs in normal operation. The user may vertically shift the AP filters 762a and 764a up and down to select a desired person or action appropriately associated with one or more messages the user is searching for. For example, the user may search for a message sent by a particular sender during a particular date range, such as last week. The user may then use this control mechanism for selecting an action to be performed on the message so found. The action may be to reply, to mark, to archive, to delete, to forward, or do any other action that is appropriate for the given message or other type of data item the user is searching for.

In some embodiments, AP filter set 752c of Option III is an implementation of left or right filters 752 and 756 of FIG. 7C, where the filter set may be manipulated by user's thumbs in normal operation. The user may rotationally shift the AP filters 780 and 782 clockwise or counterclockwise to select a desired person or action appropriately associated with one or more messages the user is searching for. For example, the user may search for a message sent by a particular sender during a particular date range, such as last week. The user may then use this control mechanism for selecting an action to be performed on the message so found. The action may be to reply, to mark, to archive, to delete, to forward, or do any other action that is appropriate for the given message or other type of data item the user is searching for.

FIG. 7E shows example search and organize interface, with multiple date range and pan controls options, configured to allow organizing and/or searching for electronic messages. In various embodiments, horizon view 790 includes electronic data items panel 792, data items 794, viewing window 796 and viewing window shift operation 798. A control panel 799 may be used to specify date range using zoom and pan operations. The control panel 799 may be implemented in a number of ways including those shown in Option I, Option II, and Option III of FIG. 7E. Option I shows an example control panel 799a with up/down zoom control and left/right pan control. Option II shows an example control panel 799b with rotational clockwise/counterclockwise zoom control. The pan control may be a left/right control. Option III shows an example control panel 799c with pinch in/out zoom control and left/right pan control.

In various embodiments, horizon view 790 includes many data items and/or groups of data items and/or groups of groups of data items, such as email or other types of messages. Those skilled in the art will appreciate that groups of groups of items may be nested to arbitrary levels without departing from the spirit of the present disclosure. To more efficiently search for particular messages, the zoom and pan operations may be employed. The zoom operation provides various levels of detail, while the pan operation allows shifting between dates on the same level of detail. For example, a high level (low detail) zoom level may present a range of several months of messages. Zooming in allows the months to show more details, such as weeks, days, or hours within which the messages were received. If the zoom level shows the level of detail including weeks within a month, then the pan operation may used to shift between weeks at the same level of detail.

In various embodiments, the viewing window may be an explicit or an implicit window. An explicit window may include a wire frame, a shaded area, a colored area, a textured area, or any other visually distinct area of the data items panel that shows the current area of focus of the user in terms of data items. As the zoom operation is applied, the data items within the viewing window 796 change the level of detail shown. For example, at a higher level the information about the data items may be limited to color coding, while at a lower level, other information such as pictures, text, texture, flags, and the like may be displayed. During a pan operation, the viewing window shifts along the horizon view to move the focus to different areas of the horizon view. Thus, using the zoom and pan operations, specific ranges of dates at certain detail levels may be viewed by the user for search or other actions.

In some embodiments, an implicit viewing window may be an invisible area of focus which may present data in a fixed area of the data item panel without showing a framed or otherwise distinct visual window.

In various embodiments, control panel 799a shown in Option I, is used to implement the zoom and pan operations by sliding a finger on a touch screen along vertical and horizontal pathways or arrows. For example, dragging a finger up and down the vertical arrow may change the zoom level, while dragging a finger left and right along the horizontal arrow may shift the viewing window accordingly. Those skilled in the art will appreciate that other touch gestures may be used to apply the zoom and pan operations without departing from the spirit of the present disclosures. For example, diagonal arrows may be used in a similar fashion.

In various embodiments, control panel 799b shown in Option II, is used to implement the zoom and pan operations by sliding a finger on a touch screen clockwise or counterclockwise along curved pathways or arrows. For example, dragging a finger clockwise may change the zoom level by zooming in, while dragging a finger counterclockwise may zoom out. As with Option I, the pan operation may be implemented by dragging a finger left and right to shift the viewing window accordingly.

In various embodiments, control panel 799c shown in Option III, is used to implement the zoom and pan operations by using a pinching or spreading multi-touch hand gesture on a multi-touch screen. For example, pinching the screen may zoom out, while spreading may zoom in, or vice versa. For the pan operation, dragging a finger left and right may shift the viewing window accordingly.

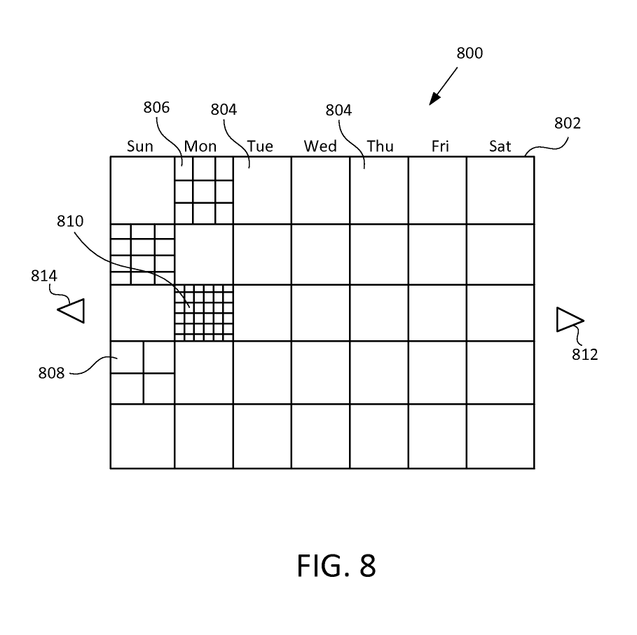

FIG. 8 shows an example calendar view of groupings of electronic messages. In various embodiments, calendar view 800 includes calendar grid 802, calendar cells 804, electronic data items grids 806, 808, and 810, calendar previous control 814 and next control 812.

In various embodiments, data items grids 806, 808, and 810 may each be horizon views within the corresponding calendar cell, each subject to independent zoom and pan operations as described at least with respect to FIGS. 7A-7E above. In some embodiments, the pan operation may be implemented as the calendar next and previous buttons which is configured to allow scrolling through various calendar dates. In some embodiments, a zoom operation may apply to the whole calendar and all cells within, while in other embodiments, zoom operations are applied independently to each cell, thus allowing each cell to be at a different detail level, as signified by calendar cells 806, 808, and 810.

In some embodiments, the zoom operation in the calendar view 800 may apply only to dates, while in other embodiments, the zoom operations may include contextual zoom, semantic zoom, and meta zoom operations applicable to any of the data item or message parameters discussed earlier, such as priority, subject, threads, people, various groups, and the like. In some embodiments, the horizon and calendar views of data items, such as electronic messages, may morph into each other as a result of the zoom in/out operation.

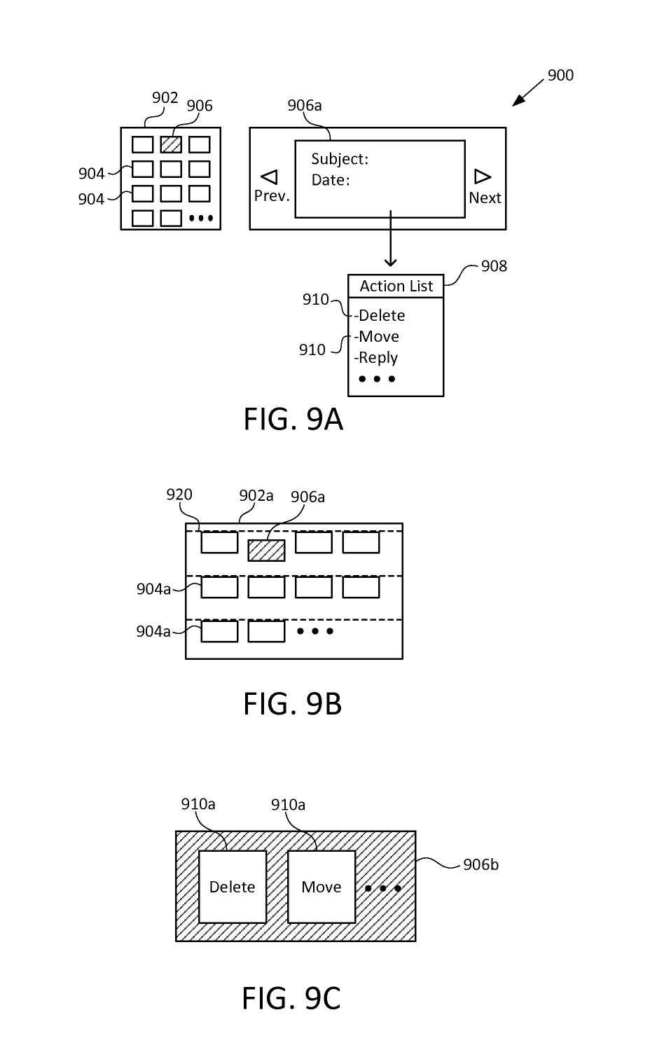

FIG. 9A shows an example arrangement configured to triage and disposition electronic messages. In various embodiments, data items triage arrangement 900 includes data items panel 902, data items 904, and selected or current data item 906. The selected data item 906a is displayed in a separate triage window or display area with previous and next controls to move to the previous or next data item, respectively. An applicable operation or action list 908 is provided to take appropriate actions 910 on the selected data item during triage. In some other embodiments, the triage actions are displayed in-place on the selected tile (data item). In some embodiments, the user indicates the desired triage action by various touch gestures (such as swipe down, swipe sideways, etc.).

In various embodiments, the user may need to triage data items, such as emails or other messages. Generally, in a triage operation, subject triage items are examined to determine what needs to be done next and then the triage items are appropriately dispositioned for future actions. For example, in a message triage arrangement, the user may want to see which messages require immediate reply, which messages may be replied to later, and which messages may be deleted.

However, the triage process can be time consuming and cumbersome. An agile user interface providing quick hand gestures for various actions and operations, such as the horizon view, may substantially reduce the time required to efficiently triage large numbers of messages or other data items.

In various embodiments, in operation, the user may zoom in on a certain number or group of data items, such as emails, in data items panel 902, and select them one by one. The currently selected email or data item 902a appears in a special triage area. In some embodiments, zoom operations may be applied to the selected email to access further details if needed for disposition. Action list 808 may be used to select one or more appropriate actions to be applied to the selected data item. For example, the action may be to move the message to a particular folder, to reply to it, or to delete it. As can be appreciated by those skilled in the art, this arrangement may be extended to selection and triage of multiple messages as once.

Generally, the action list may include actions that are applicable to the type of data item being triaged. For example, if files are being triaged, then the action list may be to copy, edit, move, delete, and the like. In some embodiments, the actions are predefined, while in other embodiments, the actions may be defined by the user, for example, using a configuration interface for setting options or preferences.

FIG. 9B shows an example arrangement configured to allow selection of an electronic message for disposition. In various embodiments, data items panel 902a includes data items 904a, selected data item 906a and data item position indicator 920. In various embodiments, selection of a targeted data item includes pushing out of position, for example, pushing down, the data item with respect to other adjacent data items. This visually distinguishes the selected data item from other data items in the group.

FIG. 9C shows an example action set for a selected electronic message usable with the arrangement of FIG. 9B. In various embodiments, selected data item 906b targeted for triage is configured to present appropriate actions 910a within the selected data item. In some embodiments, the action items 910a may be scrolled left and right or up and down to select the appropriate action. This way, many actions may be presented within the small area of the selected data item.

It will be understood that each process step in various methods described herein can be implemented by computer program instructions. These program instructions may be provided to a processor to produce a machine, such that the instructions, which execute on the processor, create means for implementing the steps described. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps to be performed in parallel. Moreover, some of the steps may also be performed across more than one processor, such as might arise in a multi-processor computer system. In addition, one or more steps or combinations of steps discussed throughout this disclosure may be performed concurrently with other steps or combinations of steps, or even in a different sequence than illustrated without departing from the scope or spirit of the disclosure.

It will also be understood that each step and combinations of steps can be implemented by special purpose hardware based systems which perform the specified actions or steps, or combinations of special purpose hardware and computer instructions.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A method of managing electronic data items, the method comprising:
using at least one software module that when executed on a computing device allows organizing groups of electronic data items, based on at least one data item characteristic, into a horizon view configured to allow viewing and manipulating large numbers of electronic data items simultaneously; and
utilizing at least one type of zoom operation to show multiple levels of detailed information about the electronic data items.

2. The method of claim 1, further comprising using a multi-finger multi-touch gesture to slide a top electronic data item in a stack of electronic data items to one side and reveal other electronic data items underneath the top electronic data item.

3. The method of claim 2, wherein the multi-finger multi-touch gesture is a three-finger multi-touch gesture.

4. The method of claim 3, wherein the three-finger multi-touch gesture comprises a reciprocating motion causing the top electronic data item to go a bottom of the stack of electronic data items and bringing a next electronic data item up to a foreground.

5. The method of claim 1, wherein the organizing groups of electronic data items comprises organizing the electronic data items into grids of grids of electronic data items.

6. The method of claim 1, wherein the electronic data items comprise one of email, SMS (Short Message Service), web-based posts, and IM (Instant Messaging).

7. The method of claim 1, further comprising searching for electronic data items based on at least one predetermined characteristic of the electronic data items.

8. The method of claim 1, further comprising filtering electronic data items based on at least one predetermined characteristic of the electronic data items.

9. The method of claim 8, wherein the electronic data item is an electronic message and the at least one predetermined characteristic is one of sending/receiving/opening time, sender, receiver, priority, relevance, importance, thread, and subject category of the electronic message.

10. The method of claim 1, wherein the electronic data items are represented by graphical tiles.

11. A system for managing electronic data items, the system comprising:
a horizon view software module that when executed on a computing device causes the computing device to categorize electronic data items, based on at least one data item characteristic, into a horizon view of multiple categories configured to allow viewing and manipulating large numbers of electronic data items simultaneously; and
a zoom software module that when executed on the computing device causes the computing device to allow at least one type of zoom operation by a user to show multiple levels of detailed information about the electronic data items.

12. The system of claim 11, further comprising a search software module and a filter software module.

13. The system of claim 11, wherein the electronic data items are electronic messages.

14. The system of claim 11, wherein the horizon view includes dynamic tiles representing electronic data items.

15. The system of claim 11, wherein the at least one type of zoom operation comprises one of a digital zoom, a context-zoom, a semantic-zoom, and a metadata-zoom.

16. The system of claim 11, wherein the multiple categories includes categories of electronic data items categorized based on at least one of time, sender, receiver, relevance, importance, message subject, message size, message reply status, flagged message, and message attachments.

17. A method of viewing electronic data items, the method comprising:
organizing groups of electronic data items, based at least on one data item characteristic, into a horizon view configured to allow viewing and manipulating large numbers of electronic data items simultaneously; and
utilizing at least one type of zoom operation to show multiple levels of detailed information about the electronic data items.

18. The method of claim 17, further comprising searching for electronic data items based on at least one predetermined characteristic of the electronic data items to view the electronic data items resulting from the search.

19. The method of claim 17, further comprising filtering electronic data items based on at least one predetermined characteristic of the electronic data items to view the electronic data items resulting from the filtering.

20. The method of claim 17, wherein the at least one type of zoom operation comprises one of a digital zoom, a context-zoom, a semantic-zoom, and a metadata-zoom.
